(19) United States
(12) Patent Application Publication
(10) Pub. No.: US 2007/0020965 A1
(43) Pub. Date: Jan. 25, 2007

(54) Hydraulic connector

(76) Inventor: Joseph Allan Nicholson, Broughton-in-Furness (GB)

Correspondence Address: SCHLUMBERGER RESERVOIR COMPLETIONS, 14910 AIRLINE ROAD, ROSHARON, TX, 77583, US

(21) Appl. No.: 10/570,465

(22) PCT Filed: Aug. 23, 2004
(86) PCT No.: PCT/GB04/03602

§ 371 Date: Mar. 2, 2006

(30) Foreign Application Priority Data
Sep. 2, 2003 (GB) 0320558.0

(51) Int. Cl. H01R 12/00

(52) U.S. Cl. 439/74

(57) ABSTRACT

A hydraulic connector for use in underwater applications. The connector comprises a plug component and receptacle component, wherein at least one of the components comprises a hydraulic wand having ports associated therewith, such that, when the plug component is inserted into a receptacle component, the ports are connected from a watertight hydraulic flow path through both components. The connector further comprises a wiper surrounding one of the hydraulic wands, the wiper having a first surface in contact with the hydraulic wand and the second surface with a continuously increasing radius arranged, in use, to direct debris away from the hydraulic flow path as the plug component is inserted in the receptacle component. The connector may further comprise at least one scraper ring positioned around the wand and inside an outer housing on the receptacle component.

The present invention relates generally to hydraulic connectors, and more specifically to hydraulic connectors for use in exceptionally harsh environments, such as sub-sea and oil well applications.

In recent times there has been an increasing need to provide complex machinery in sub-sea locations for use in oil and gas wellheads as well as for other sub-sea applications. However, equipment associated with sub-sea and oil/gas well applications experiences high pressure and temperature during continuous operation. Furthermore, the environments in which such equipment is being operated are harsh in terms of levels of particulate contaminants and the potential for sea water or well fluid ingress.

Accordingly, it is exceptionally difficult to provide hydraulic connections which are both capable of withstanding the high pressures and temperatures involved in continuous operation and provide a sufficient barrier to contamination from sand, grit, etc. In addition, it is extremely difficult to provide such connectors which are simple to operate remotely and/or in harsh environments.

The present invention seeks to provide a hydraulic connector assembly that can be employed in a harsh environment, such as a sub-sea or well-bore location, yet which overcomes some of the above problems. The present invention also aims to provide a self-cleaning connector which does not suffer from contamination problems.

According to the present invention there is provided
a hydraulic connector, for use in underwater applications, the connector comprising:
a plug component and a receptacle component, wherein at least one of the components comprises a hydraulic wand having ports associated therewith, such that, when the plug component is inserted into the receptacle component, the ports are connected to form a water tight hydraulic flow path through both components;
the connector further comprising a wiper surrounding one of the hydraulic wands, the wiper having a first surface in contact with the hydraulic wand and a second surface with a continuously increasing radius arranged, in use, to direct debris away from the hydraulic flow path as the plug component is inserted into the receptacle component.

The connector of the present invention is self-cleaning and has very little fluid exchange. The wiper deflects debris away from the direction of insertion, and hence away from the wand ports. The self-cleaning effect is enhanced by a flushing action generated as the plug component is inserted into the receptacle component, creating a piston effect. The hydraulic porting system is configured with the wiper system to create a linear connection with a high tolerance to axial engagement tolerances.

Additionally, the central components of the hydraulic connector are protected from the effects of sand, which could block the wiper mechanism.

An additional benefit is that the shape of the wiper enables a seal to be made with the plug housing on engagement.

An example of the present invention will now be described with reference to the accompanying drawings, in which:

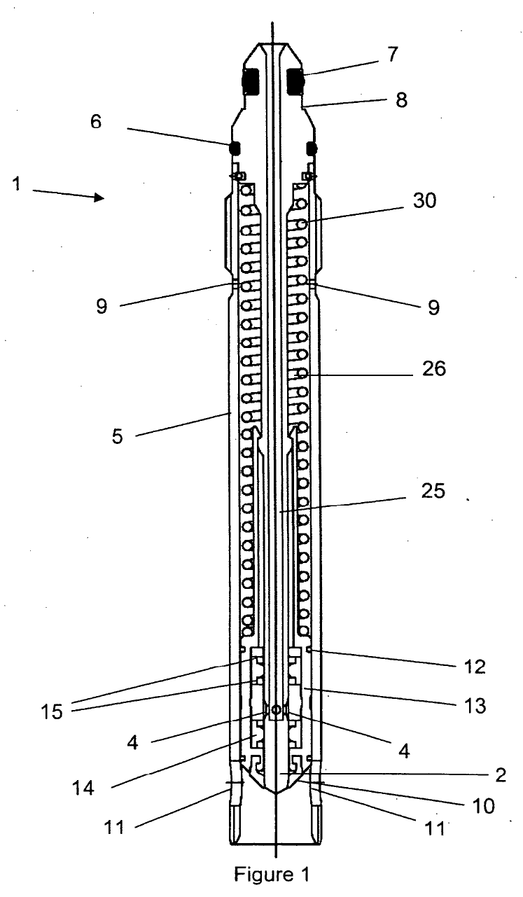

FIG. 1 shows a cross sectional view of a receptacle component of a connector according to the present invention;

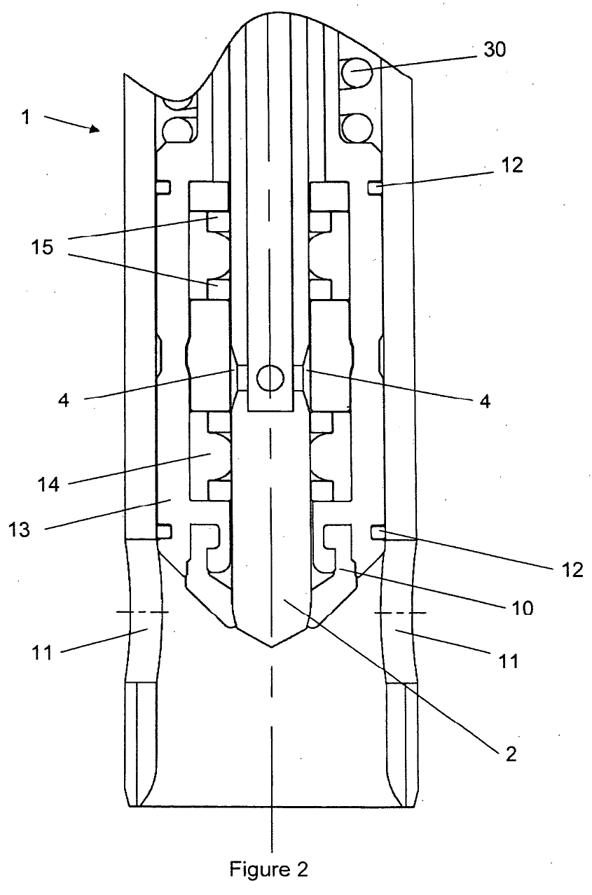

FIG. 2 shows part of the component of FIG. 1 in greater detail;

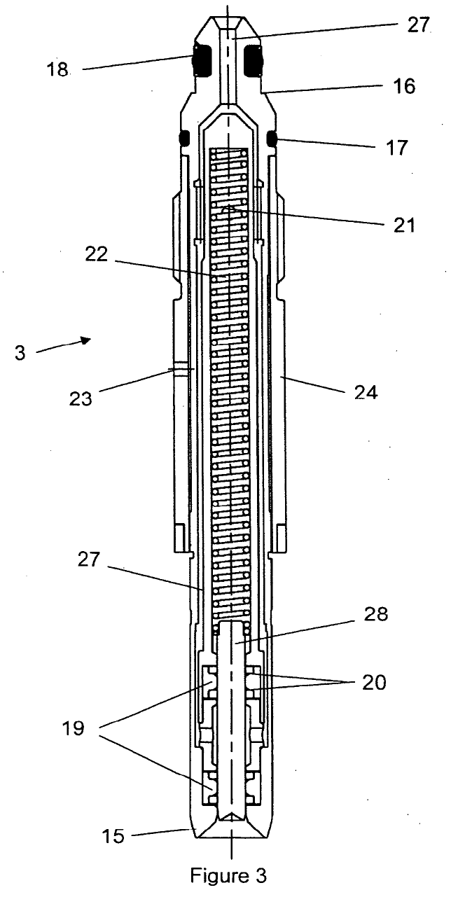

FIG. 3 shows a cross-sectional view of a plug component of a connector according to the present invention;

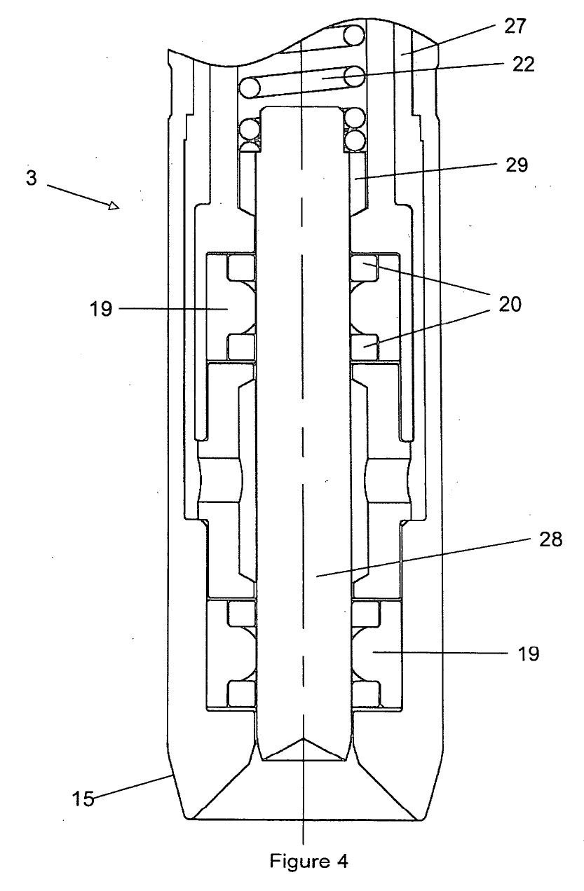

FIG. 4 shows part of the component of FIG. 3 in greater detail;.

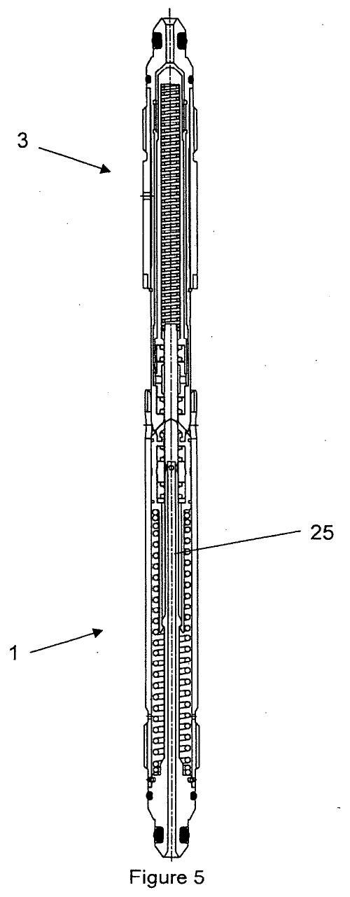

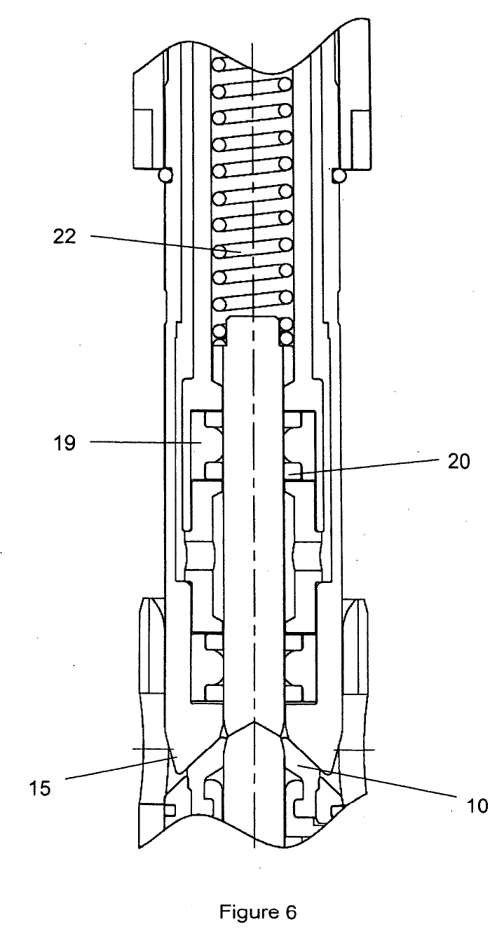

FIG. 5 and FIG. 6 show cross-sectional views of the first stage of engagement of a connector according to the present invention;

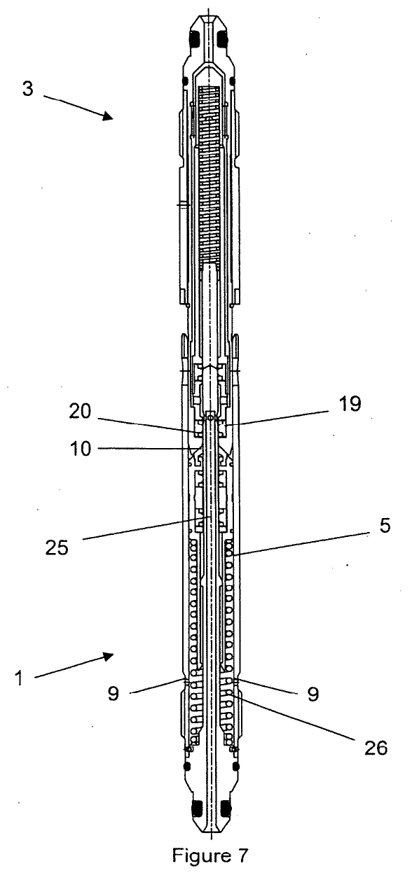

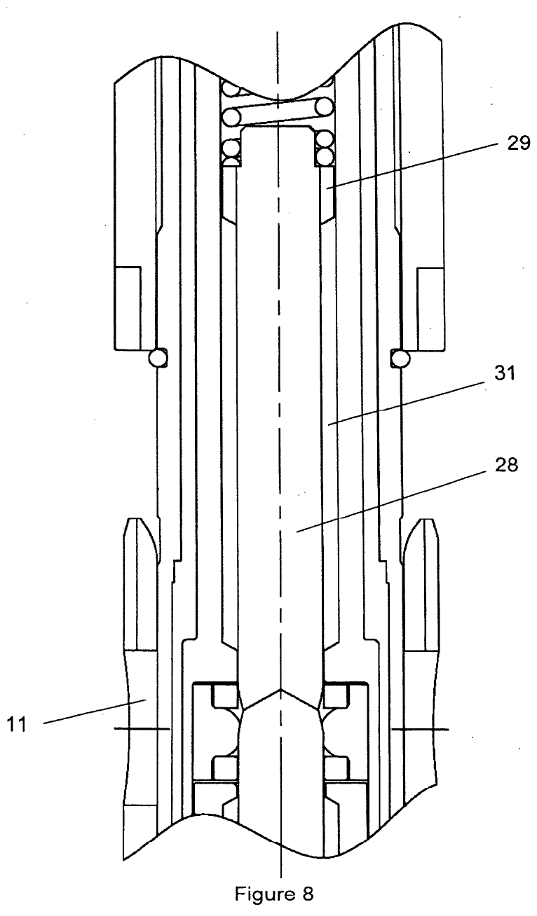

FIG. 7 and FIG. 8 show cross-sectional views of the second stage of engagement of a connector according to the present invention; and

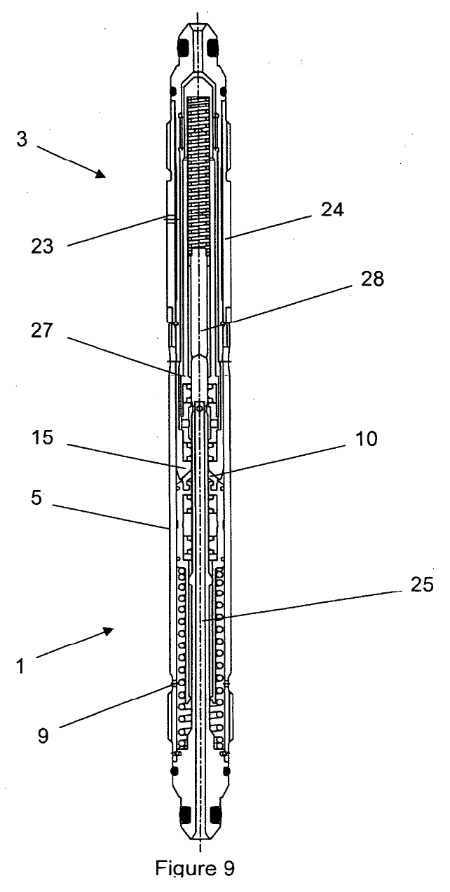

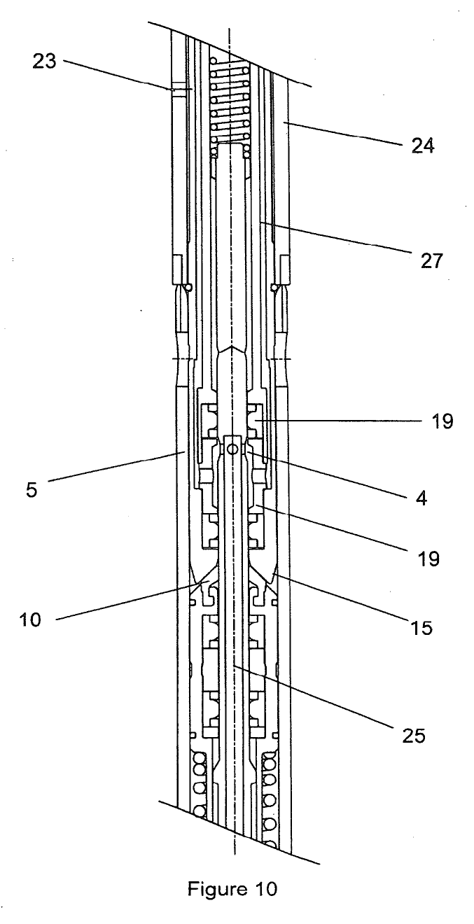

FIG. 9 and FIG. 10 show cross-sectional views of an engaged connector according to the present invention.

A receptacle component 1 of a connector according to the present invention is illustrated in FIG. 1 and FIG. 2. The receptacle component 1 has a hydraulic wand 2, through which hydraulic fluid flows when the receptacle component 1 is connected to a plug component 3 (see FIG. 3 and FIG. 4). At the engaging end of the wand 2 there are wand ports 4, which, in use, connect the hydraulic flow path in the receptacle 1 and plug 3 components. Receptacle component 1 has a threaded retaining sleeve 5 and various seals 6, 7 and 8 which provide a high pressure sealing capability for the hydraulic pressure, and prevent water ingress in use when the connector is attached to a housing (not shown). Vent ports 9 are positioned in the sleeve 5 to allow venting of fluid during connection of the connector.

A wiper 10 surrounds the hydraulic wand 2. Debris ports 11 are positioned at the engaging end of the threaded retaining sleeve 5, so that, in use, debris directed away from the hydraulic flow path and wand 2 by the wiper 10 will be ejected through the debris ports 11. The receptacle component 1 has in this example further debris scraper rings 12 to prevent debris ingress between sleeve 5 and the other receptacle components.

A seal stack shuttle assembly 13 fits around the wand 2 and scraper rings 12 and houses elastomer seals such as a “T” seal 14. Anti-extrusion back up rings 15 are provided to prevent deformation of the T seals 14 and are ideally made from PEEK thermoplastic or similar high performance material.

A plug component 3 of the connector 1 is illustrated in FIG. 3 and FIG. 4. A plug nose 15 of the plug component 3 engages, in use with the wiper 10 of the receptacle component 1. Similarly to the receptacle compartment 2, the plug component 3 has various seals 16 to 20 which can engage with an outer housing (not shown). A vent hole 21 is positioned adjacent a biassing member 22 and additionally there is a vent port 23 and a retaining nut 24. The retaining nut 24 prevents over-insertion when the plug 3 and receptacle 1 components are engaged.

FIGS. 5 to 10 show the stages of engagement of the receptacle component 1 with the plug component 3. Referring to FIG. 5 and FIG. 6, to engage the connectors, the plug nose 15 of plug component 3 is inserted into engagement with the receptacle component 1. As the plug nose 15 of the plug component 3 enters the shrouds of the receptacle component 1, the wiper 10 pushes debris such as sand and grit away from the hydraulic wand 2 and out through vent ports 11. This is enhanced by the flushing action of the components 1, 3 as they are brought together, with the piston effect of the plug nose 15 entering the shroud of the receptacle connector 1. As well as the ramping profile of the wiper 10 deflecting debris, it protects the hydraulic wand 2 and central pin 25 from the effects of sand by acting in combination with seals 14 and scraper rings 12. Sand can jam the mechanism. When the plug nose 15 of the plug component 3 is in the shroud of the receptacle component 1 as shown in FIG. 5 and FIG. 6, the components in 1 and 3 are then aligned.

Water and debris ejected from the wiper 10 and plug nose 15 interface is ejected though the debris ports 11.

As the plug 3 and receptacle 1 components are further pushed together, as shown in FIG. 7 and FIG. 8, the wand 2 and central pin 25 centralizes and engages with the plug shuttle piston 28 which is spring energised by spring 22 and shuttle piston 28 is displaced through seals 19. At the same time, the seal stack assembly 13 is displaced axially by the plug nose 15 by depressing spring 30.

Displaced fluid in the receptacle retaining sleeve 5 internal cavity is vented through ports 9. In the plug component 3 fluid from cavity 31 is displaced through ports 23. Vent slots 29 allow fluid to move across the shuttle piston 28 as the shuttle piston is depressed by the wand 2. At this stage in FIG. 8 the connection is shown at the minimum engaged position with hydraulic flow now possible.

As the plug 3 and receptacle 1 components move further together, the sleeve 5 comes to abut with the edge of the nut 24 of plug component 3 as shown in FIG. 9 and FIG. 10. In this position, the connectors are fully engaged to their maximum linear position and the wand ports 4 are within the sealing position of seals 19 maintaining flow path 27 in the plug component 3, so that there is a hydraulic flowpath through the entire engaged connector.

The described connector engages without being contaminated by debris such as sand and silt, due to the wiper 10 action and aided by the scraper rings 12 which also prevent any jamming by debris.

The connector can be engaged and separated with minimal force, as there is no separating force generated across the mating components 1 and 3 from hydraulic pressure in the hydraulic fluid because of the spool valve arrangement of the parts.

The wiper 10 establishes a face seal with a plug nose 15 on engagement. The “T” seal arrangement with PEEK thermoplastic backup rings provide very good anti-extrusion characteristics for reliable sealing at elevated temperatures and pressures. The various seals only engage when the connector is in alignment and alignment control is initially achieved by a remote tool or housing which the connector is mounted inside. After this, alignment is achieved from the plug nose 15 and geometry of the shroud of the receptacle connector 1. The connector has large stack-up capabilities.

A retaining nut 24 prevents over-stroking on engagement. The vent ports 9 and 23 which allow displacement of fluid mean that the sliding seal stock 13 and shuttle piston 28 can move freely within the components 1 and 3.

1. A hydraulic connector, for use in underwater applications, the connector comprising:
a plug component and a receptacle component, wherein at least one of the components comprises a hydraulic wand having ports associated therewith, such that, when the plug component is inserted into the receptacle component, the ports are connected to form a water tight hydraulic flow path through both components;
the connector further comprising a wiper surrounding one of the hydraulic wands, the wiper having a first surface in contact with the hydraulic wand and a second surface with a continuously increasing radius arranged, in use, to direct debris away from the hydraulic flow path as the plug component is inserted into the receptacle component.

2. A connector according to claim 1, further comprising at least one scraper ring positioned around the wand and inside an outer housing on the receptacle component.

3. A connector according to claim 1 or claim 2, wherein at least some of the hydraulic ports are arranged in a spool valve arrangement.

4. A connector according to any preceding claim, further comprising at least one “T” seal arranged, in use, to seal the connector around least one of the hydraulic ports when not connected.

5. A connector according to any preceding claim, further comprising a biassing member for each of the plug and receptacle components to bias each component towards a sealed position.

6. A connector according to any preceding claim, wherein the receptacle component has vent ports on an outer housing to allow venting of the debris directed from the wiper in use.

7. A connector according to any of the preceding claims, wherein the plug component has an engaging nut which limits, in use, the insertion of the plug component into the receptacle component.

8. A connector according to any of the preceding claims, further comprising an engaging member for engaging with the wiper.
